(19) United States
(12) Patent Application Publication
(10) Pub. No.: US 2019/0297358 A1
(43) Pub. Date: Sep. 26, 2019

(54) SYSTEMS AND METHODS FOR CUSTOMIZING BROADCAST VIDEO

(71) Applicant: MULTICHOICE SUPPORT SERVICES (PTY) LTD, Randburg (ZA)

(72) Inventor: Willem Andries NEL, Randburg (ZA)

(21) Appl. No.: 16/304,576

(22) PCT Filed: Feb. 28, 2018
(86) PCT No.: PCT/IB18/51276

§ 371 Date: Nov. 26, 2018

(51) Int. Cl. H04N 21/2343; H04N 21/84; H04N 21/8543; H04N 21/431

(52) U.S. Cl. CPC H04N 21/2343; H04N 21/84; H04N 21/6143; H04N 21/431; H04N 21/8543

(57) ABSTRACT

In one example, content assets and customization items are obtained at a head-end system. For each customization item, one or more target attributes are obtained that include customer attributes relating to groups of customers. A rule file is generated that has a hierarchical tree structure with a plurality of nodes at different hierarchical levels of the tree structure, the customer attributes forming nodes at one or more intermediate hierarchical levels of the tree structure and the customization item identifiers forming end nodes of the tree structure. The rule file is broadcast to a plurality of customer decoders which each store the rule file on a local memory, and then traverse the rule file by comparing customer attributes that are stored on or accessible by the customer decoder with the customer attributes in the tree structure to obtain a customization item identifier at an end node.

### FIELD OF THE INVENTION

This invention relates to broadcasting, which may be by means of satellite digital video broadcasting, cable broadcasting, terrestrial broadcasting or Internet-broadcasting. More specifically, it relates to digital video broadcasting in which set-top boxes or other consumer devices receive digital broadcasts and are able to decode such broadcasts so as to play back digital content.

### BACKGROUND TO THE INVENTION

Customer set-top boxes may be used to decode digital video broadcasts to enable customers to enjoy broadcast content. Set top boxes are typically provided with a unique subscriber identifier and related keys so as to configure the set-top box to decode the channels or services the consumer has subscribed to.

Newer set-top boxes may include a hard drive for storing digitally broadcast content for later playback. These set-top boxes may be unconnected or offline in that they are not connected to the Internet or other communication networks. Even for those devices that do have the ability to connect to the Internet, such as the applicant's own DSTV EXPLORA™ set-top box, many consumers may not connect those devices to the Internet and they therefore remain unconnected with only the ability to receive digital broadcasts but no way to communicate bi-directionally.

In linear video broadcasting, a schedule of broadcast content is established at a head-end system and content assets are broadcast linearly according to the schedule. Different content assets such as primary broadcast content (e.g. movies or shows), pre-view content, and advertisements, are broadcast according to the schedule and received by all customers. In linear video broadcasting, it is not possible to deliver content in which the various content assets have been customised for specific customers or groups of customers. A linear broadcast which is recorded by a set-top box and replayed at a later time will be exactly the same as when it was broadcast.

Rather than simply storing linear video broadcasts, modern set-top boxes such as the DSTV EXPLORA™ are configured to store separately broadcast content assets on their local hard drives, where each content asset is a separate digital file. Error correcting codes are used to ensure that each file is fully and correctly received before it is stored on the set-top box hard drive.

Such additional broadcast content assets are included in the digital broadcast stream on a carousel in which each broadcast content asset file is transmitted one after the other and the sequence repeats every few days, so that a set-top box which was switched off when a broadcast content asset was transmitted receives it within at most a few days. The locally stored files can then be selected for later playback by a customer. The customer experience is of receiving on-demand video, although the system is not on-demand in a true sense as the content files have been stored on the local hard drive. The applicant's own DSTV CATCH UP™ is an example of this technology.

Locally stored content assets may include primary desired content such as shows, movies or sports event. However, it may be desirable to include other content together with the primary content when the locally stored content file is replayed by a customer. Such other content may, for example, be previews, advertisements (ads), or promotional items. While such other content may simply be included into the same file as the primary broadcast content when the content is prepared at the head-end system, doing so does not permit the other content items to be customised for a particular customer or group of customers. Furthermore, other content items that may be the same in multiple stored content asset files must nevertheless be included in each content file which utilizes additional storage space on the set-top box. Other content items that may be inappropriate or inapplicable when the content file is selected by a user cannot be removed or replaced.

Systems exist which may enable content such as ads to be inserted on connected set-top boxes in which all of the business logic resides on the decoder. These systems only work on connected set-top boxes that have bi-directional communication and suffer from high complexity in that set top boxes must be configured with complex rules to determine which advertisements to select. If any business logic changes, all set-top boxes require a software update.

There exists a need to enable set-top boxes, including those that are unconnected, to be configured to present content in a customized way, where the display, selection and/or combination of content assets is customizable based on the customer and/or the circumstances in which the selection of that content occurs.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to an aspect of the technology there is provided a computer-implemented method of customizing broadcast video, the method performed at a head-end computer system and comprising:
obtaining a number of content assets, each content asset being a digital video file that has an identifier;
obtaining a number of customization items, each customization item being a digital file that has an identifier;
for each customization item, obtaining one or more target attributes, the target attributes including customer attributes that relate to groups of customers;
generating a rule file, the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
causing broadcasting of the rule file to a plurality of customer decoders, each customer decoder storing the rule file on a local memory of the customer decoder;
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization identifier.

Further features provide for the customer decoder to traverse or query the hierarchical structure of the rule file upon selection of a content asset for video playback by a user of the customer decoder, and wherein the customer decoder customizes playback of the selected content asset.

The customer attributes may include a region of a customer, the type of service the customer has subscribed for, and demographic information about the customer.

Further features provide for the target attributes to include a customer selected service, and for the customer selected service to form nodes at a further intermediate hierarchical level of the tree structure. The customer decoder may traverse or query the hierarchical tree structure by comparing a service through which the content asset is selected with the customer selected service in the tree structure.

Further features provide for each content asset to have a number of content asset attributes, for the target attributes of each customization item to include content asset attributes, and for generating the rule file to include matching the content asset attributes with customization item target attributes so as to match customization items with content assets, and to include content asset identifiers at an intermediate hierarchical level of the tree structure. The content asset attributes may include: a channel in which the content asset is broadcast, a season of the content asset, a series to which the content asset belongs, a studio which created the content asset, or a genre of the content asset.

Further features provide for the rule file to be a text file or a database file. The text file may be in a format such as Json™ or extensible mark-up language (XML) and the database file may be an structured query language (SQL) database file SQL database file.

In one embodiment the customization items are digital video files that may include advertising content, preview content, promotional content, channel pre-roll or service pre-roll, and the customer decoder may customize the content asset by causing playback of the stored customization item in association with the content asset. More than one customization item may be included as an end node of the tree structure beneath a content asset identifier node to enable multiple customization items to be played back in association with one content asset.

In a different embodiment the customization items may be instructions to the customer decoder to modify a user interface defined by the customer decoder.

Further features provide for the method to include: causing broadcasting of the content assets as separate digital video files to the customer decoders, the customer decoders storing the content asset digital video files on the local memory; and causing broadcasting of the customization items as separate digital files to the customer decoders, the customer decoders storing the content customization digital files on the local memory.

Further features provide for broadcasting of the content assets to be done in a sequential manner in which the content assets are included in a carousel and broadcast one after the other with the sequence repeating.

Further features provide for broadcasting of the customization items to be done in a sequential manner in which the customization items are included in a carousel and broadcast one after the other with the sequence repeating.

Further features provide for the rule file to be re-generated and broadcast on a periodic basis, the customer decoders replacing an existing rule file stored on the local memory with the most recently broadcast rule file. Replacing of an existing rule file with a more recently broadcast rule file occurs without requiring any logic updates to the customer decoders. The rule file can also be re-generated and broadcast on an ad hoc basis by the head-end system.

Further features provide for the method to include an initial step of causing the broadcasting of a configuration file to the customer decoders, the configuration file including a list of customer identifiers and for each customer identifier applicable customer attributes associated with that customer identifier, wherein a customer decoder linked to a customer identifier stores the applicable customer attribute. The customer attributes may be stored as conditional access products on the local memory of the customer decoder.

Further features provide for the broadcasting to be digital satellite broadcasting, cable broadcasting, or terrestrial broadcasting; and for at least some of the customer decoders to be unconnected or offline in that they are not connected to the Internet or other communication network and are therefore not able to communicate bi-directionally. The head-end computer system may be a satellite or terrestrial broadcasting head-end system. Further features provide for the customer decoder to be a dedicated set-top box.

According to another aspect of the technology there is provided a computer-implemented method of customizing broadcast video, the method performed at a customer decoder and comprising:
accessing a number of content assets, each content asset being a digital video file that has an identifier;
accessing a number of customization items, each customization item being a digital file that has an identifier and wherein each customization item has one or more target attributes, the target attributes including customer attributes that relate to groups of customers;
receiving a rule file and storing the rule file on a local memory of the customer decoder the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure; and
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization identifier.

Further features provide for the customer decoder to traverse or query the hierarchical structure of the rule file upon selection of a content asset for video playback by a user of the customer decoder, and wherein the customer decoder customizes playback of the selected content asset.

Further features provide for the customer decoder to traverse or query the hierarchical tree structure by comparing a service through which the content asset is selected with the customer selected service in the tree structure. The customer decoder may customize the content asset by causing playback of the stored customization item in association with the content asset.

The method may include: receiving the content assets as separate digital video files at the customer decoder, the customer decoder storing the content asset digital video files on the local memory; and receiving the customization items as separate digital files at the customer decoder, the customer decoder storing the content customization digital files on the local memory. Receiving the content assets may be done in a sequential manner in which the content assets are included in a carousel and broadcast one after the other with the sequence repeating. Receiving the customization items may be done in a sequential manner in which the customization items are included in a carousel and broadcast one after the other with the sequence repeating.

Further features provide for a re-generated rule file to be received on a periodic basis, the customer decoder replacing an existing rule file stored on the local memory with the most recently broadcast rule file.

Further features provide for an initial step of receiving a configuration file including a list of customer identifiers and for each customer identifier one or more customer attributes to be associated with that customer identifier, wherein a customer decoder linked to a customer identifier stores an applicable customer attribute. The customer attributes may be stored as conditional access products on the local memory of the customer decoder.

The steps of receiving at the customer decoder may be via digital satellite broadcasting, cable broadcasting or terrestrial broadcasting and the customer decoder may be unconnected or offline Zand not able to communicate bi-directionally.

According to another aspect of the technology, there is provided a head-end system for customizing broadcast video, the system including a memory for storing computer-readable program code and a processor for executing the computer-readable program code, the system comprising:
a content asset obtaining component for obtaining a number of content assets, each content asset being a digital video file that has an identifier;
a customization item obtaining component for obtaining a number of customization items, each customization item being a digital file that has an identifier;
a target attribute obtaining component, for each customization item, obtaining one or more target attributes, the target attributes including customer attributes that relate to groups of customers;
a rule engine for generating a rule file, the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
a rule file broadcast component for causing broadcasting of the rule file to a plurality of customer decoders, each customer decoder storing the rule file on a local memory of the customer decoder;
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization identifier.

Further features provide for the customer decoder to traverse or query the hierarchical structure of the rule file upon selection of a content asset for video playback by a user of the customer decoder, and wherein the customer decoder customizes playback of the selected content asset.

Further features provide for each content asset to have a number of content asset attributes, the target attributes of each customization item including content asset attributes, and the rule engine for generating the rule file including matching the content asset attributes with customization item target attributes so as to match customization items with content assets, and to include content asset identifiers at an intermediate hierarchical level of the tree structure.

The system may include: a content asset broadcast component for causing broadcasting of the content assets as separate digital video files to the customer decoders, the customer decoders storing the content asset digital video files on the local memory; and a customization item broadcast component for causing broadcasting of the customization items as separate digital files to the customer decoders, the customer decoders storing the content customization digital files on the local memory. The content asset broadcast component may broadcast the content assets in a sequential manner in which the content assets are included in a carousel and broadcast one after the other with the sequence repeating. The customization item broadcast component may broadcast the customization items in a sequential manner in which the customization items are included in a carousel and broadcast one after the other with the sequence repeating.

Further features provide for the rule file engine to re-generate the rule file and broadcast on a periodic basis, the customer decoders replacing an existing rule file stored on the local memory with the most recently broadcast rule file.

Further features provide for the system to include a configuration component for broadcasting a configuration file as an initial step to the customer decoders, the configuration file including a list of customer identifiers and for each customer identifier one or more customer attributes to be associated with that customer identifier, wherein a customer decoder linked to a customer identifier stores an applicable customer attribute.

According to another aspect of the technology, there is provided a customer decoder for customizing video in direct-to-home broadcasting the decoder including a memory for storing computer-readable program code and a processor for executing the computer-readable program code, the customer decoder comprising:
a content asset accessing component for accessing a number of content assets, each content asset being a digital video file that has an identifier;
a customization item accessing component for accessing a number of customization items, each customization item being a digital file that has an identifier and wherein each customization item has one or more target attributes, the target attributes including customer attributes that relate to groups of customers;
a rule file receiving component for receiving a rule file and storing the rule file on a local memory of the customer decoder the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure; and
a rule file traversing component, wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and a customization component for customizing video at the customer decoder by obtaining the customization item corresponding to the customization identifier.

Further features provide for a rule file traversing component to traverse or query the hierarchical structure of the rule file upon selection of a content asset for video playback by a user of the customer decoder, and the customization component to customize playback of the selected content asset.

The customization component may cause playback of the stored customization item in association with the content asset. Further features provide for an interface component for modifying a user interface defined by the customer decoder in accordance with instructions provided by the customization items.

Further features provide for the customer decoder to include: a content asset receiver for receiving the content assets as separate digital video files at the customer decoder, the customer decoder storing the content asset digital video files on the local memory; and a customization item receiver for receiving the customization items as separate digital files at the customer decoder, the customer decoder storing the content customization digital files on the local memory.

Further features provide for the rule file receiving component to receive a re-generated rule file on a periodic basis, the customer decoder replacing an existing rule file stored on the local memory with the most recently broadcast rule file.

Further features provide for the decoder to include a configuration receiving component for receiving a configuration including a list of customer identifiers and for each customer identifier one or more customer attributes to be associated with that customer identifier, wherein a customer decoder linked to a customer identifier stores an applicable customer attribute.

The customer attributes may be stored as conditional access products on the local memory of the customer decoder. The decoder may receive broadcasts via digital satellite broadcasting, cable broadcasts or terrestrial broadcasts and the customer decoder may be unconnected or offline and is not able to communicate bi-directionally. In one embodiment, the decoder is a dedicated set-top box.

In this specification, the term “customer decoder” is to be construed broadly and covers both dedicated set top boxes as well as multipurpose computing devices such as personal computers or mobile devices that have been configured with the necessary decoding ability.

According to another aspect of the technology, there is provided a computer program product for customizing broadcast video, the computer program product comprising a computer-readable medium having stored computer-readable program code for performing the steps of:
obtaining a number of content assets, each content asset being a digital video file that has an identifier;
obtaining a number of customization items, each customization item being a digital file that has an identifier;
for each customization item, obtaining one or more target attributes, the target attributes including customer attributes that relate to groups of customers;
   generating a rule file, the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
causing broadcasting of the rule file to a plurality of customer decoders, each customer decoder storing the rule file on a local memory of the customer decoder;
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization identifier.

According to another aspect of the technology, there is provided a computer program product for customizing broadcast video, the computer program product comprising a computer-readable medium having stored computer-readable program code for performing the steps of:
accessing a number of content assets, each content asset being a digital video file that has an identifier;
accessing a number of customization items, each customization item being a digital file that has an identifier and wherein each customization item has one or more target attributes, the target attributes including customer attributes that relate to groups of customers;
receiving a rule file and storing the rule file on a local memory of the customer decoder the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization identifier.

Embodiments of the invention will now be described, by way of example only, with reference to the accompanying drawings.

### BRIEF DESCRIPTION OF THE DRAWINGS

In the drawings:

FIG. 1 is a schematic illustration of an example embodiment of a system for customizing video according to embodiments of the invention;

FIG. 2 is a block diagram of an example embodiment of logical components of the head-end system;

FIG. 3 illustrates one example of a rule file that is a text file;

FIG. 4 is a flow diagram showing an example embodiment of steps carried out by a rules engine in generating a rule file;

FIG. 5 illustrates one example of a method of assigning customization items to content assets by attribute;

FIG. 6 is a swim-lane flow diagram showing example embodiments of methods carried out at the head-end system and the customer decoder;

FIG. 7A is a block diagram of an example embodiment of a head-end system;

FIG. 7B is a block diagram of an example embodiment of a customer decoder; and

FIG. 8 is an example embodiment of a computer system that may be used in implementations of the head-end system and/or customer decoder.

### DETAILED DESCRIPTION WITH REFERENCE TO THE DRAWINGS

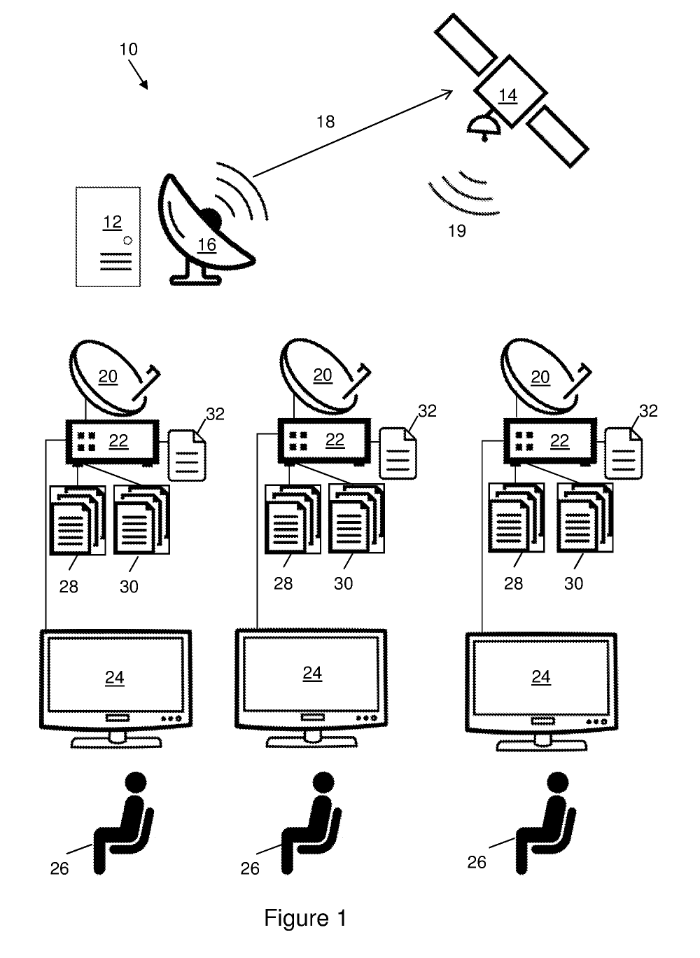

FIG. 1 illustrates an example embodiment of a system (10) for customizing broadcast video. The system (10) includes a head-end computer system (12) which in this example is a satellite broadcasting head-end system, but may also be a cable broadcasting head-end system, a terrestrial broadcasting head-end system or an Internet broadcasting head-end system. In this example the head-end system (12) is able to communicate with one or more satellites (14) by means of a transmitter (16) through a dedicated uplink (18). The satellite (14) may be a geo-stationary or low-earth orbit satellite.

Although some embodiments refer to satellite broadcasting, in other embodiments the head-end system (12) communicates with transmitters that could be terrestrial broadcasting transmitters, cable broadcasting transmitters or Internet-based transmitters. In all described embodiments below, satellite broadcasting could therefore be replaced with, for example, digital terrestrial television (DTT) broadcasting, cable broadcasting through for example a Digital Video Broadcasting—Cable (DVB-C) standard, or Internet-based broadcasting.

The satellite (14) receives digital data from the transmitter (16) and broadcasts signals (19) that are received by a plurality of digital receivers (20). Each receiver (20) may be associated with a customer decoder (22) that is able to decode the broadcast signals (19). The broadcast signals may be digital satellite television broadcasts and the customer decoders (22) may be dedicated set-top boxes or, in some embodiments, multipurpose computing devices such as personal computers or mobile devices that have been configured with the necessary decoding ability. A customer decoder (22) is connected to or provided with a display (24) at which a user (26) is able to watch the digital satellite television broadcast. The user (26) may be a subscriber to whom the customer decoder (22) belongs. In some embodiments, the customer decoder (22) may be offline or unconnected in that it is only able to receive the decoded broadcast signals (19) and is not connected to any communication network and is therefore not able to communicate bi-directionally.

Each customer decoder (22) has a local memory on which a number of content assets (28) can be stored. Each content asset (28) is a digital video file that has a unique identifier, and includes primary content that a user (26) desires to watch. Examples of content assets (28) include shows, movies or sports events. The local memory also stores a number of customization items (30). Each customization item (30) is a digital file that has a unique identifier. A rule file (32) is also stored on the local memory of each customer decoder (22).

In embodiments of this disclosure, upon selection of a content asset (28) for video playback by a user (26), the customer decoder (22) uses the rule file (32) to obtain one or more customization item identifiers and then customizes the playback of the selected content asset (24) by obtaining the customization item(s) (30) corresponding to the customization item identifier(s).

In other embodiments, upon the user (26) performing a different action, such as activating the customer decoder (22) or selecting a menu option, the customer decoder (22) uses the rule file (32) to obtain one or more customization item identifiers and then modifies a user interface defined by the customer decoder (22) by obtaining a customization item(s) (30) corresponding to the customization item identifier(s).

The customization items (30) may, in the first-mentioned embodiment, be digital video files that may include advertising content, promotional content, channel pre-roll or service pre-roll, and customizing the playback of the selected content asset (28) may include causing playback of the stored customization item(s) (30) in association with the content asset (28). In a different embodiment, the customization item(s) (30) may be instructions to the customer decoder (22) to modify a user interface defined by the customer decoder.

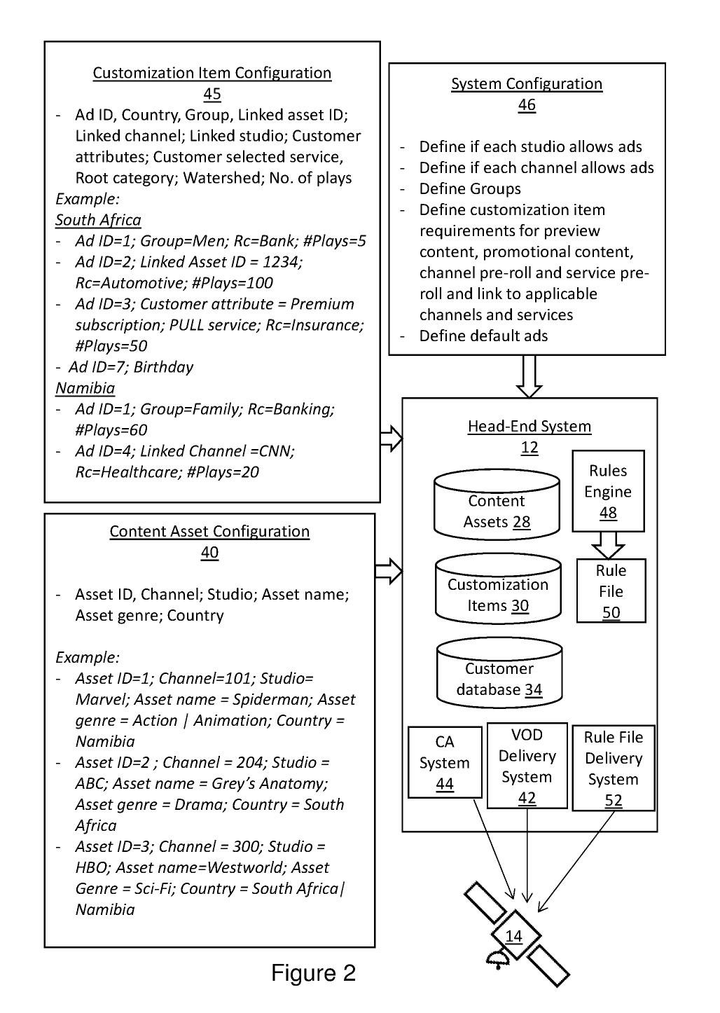

FIG. 2 is a block diagram of logical components of the head-end system (12) according to an embodiment. The head-end system (12) has a database that stores content assets (28) and a database that stores customization items (30). It further includes a customer database (34) which stores records for each subscriber to an applicable digital broadcast service, including customer attributes for that subscriber. Typically, each customer subscriber has a unique subscriber identifier which identifies the customer and which is linked to a customer smart-card which the customer can insert into the customer decoder (22), or where the subscriber identifier is provided by software installed on the customer decoder (22). Customer attributes may include a region of the customer (e.g. a province or city name in which the customer resides), the type of service(s) the customer has subscribed for (e.g. a compact, standard or premium subscription), and demographic information about the customer (e.g. customer age, birthday, gender, income level, and so on).

Each content asset (28) has an associated content asset record with a unique identifier (Asset ID) and includes a number of content asset attributes. The content asset attributes can be configured by a user of the head-end system (12) for each content asset (28) as shown in block 40. Content asset attributes may include a channel with which the content asset is associated, a studio that produced the content asset, a name of the content asset, one or more genres of the content asset and a list of countries to which the content asset is to be broadcast. In the illustrated example, three content asset records with their associated content asset attributes are shown. The first has an Asset ID of 1, is associated with the satellite broadcaster's channel 101, was produced by Marvel Entertainment, the asset name is “Spiderman”, the genres are action and animation and the country to which it is broadcast is Namibia. The second asset record has an Asset ID of 2, is associated with the satellite broadcaster's channel 204, is produced by American Broadcasting Company, the asset name is “Grey's Anatomy”, the genre is drama and the country to which it is broadcast is South Africa. The third asset record has an Asset ID of 3, is associated with the satellite broadcaster's channel 300, is produced by Home Box Office, the asset name is “Westworld”, the genre is sci-fi and the countries are South Africa and Namibia. Of course, although only three content asset records are shown, in a working system there will at least hundreds or even thousands of content assets.

Content assets (28) on the head-end computer system's database are delivered to customer decoders (22) by means of a video on demand (VOD) delivery system (42). The VOD delivery system (42) places the content assets (28) in a virtual carousel and transmits them sequentially to the satellite (14), the satellite broadcasting them one after the other as separate digital video files with the sequence in the carousel repeating. The customer decoders (22) receive the content assets (28) and store them on the local memory as separate digital video files for later playback by the user (26). The full content asset record with its content asset attributes is generally not included in the broadcast to the customer decoders, and in some embodiments the only content asset meta-data that the customer decoders receive are the unique identifiers (Asset ID). This results in less complexity on the customer decoders as will become apparent from what follows.

The head-end system (12) also includes an identification system which in this case is a conditional access (CA) system (44). The CA system (44) is able to transmit customer attributes it obtains from the customer database (34) for broadcast to the customer decoders (22) by the satellite (14). The broadcast includes a configuration file that includes a list of customer identifiers and the applicable customer attributes for each customer identifier. A customer decoder looks for a customer identifier in the configuration file that matches the customer identifier at the customer decoder. If a match is found then the customer decoder stores the associated customer attributes in a dedicated portion of the memory of the customer decoder in what are referred to as “conditional access products”. The applicant's EXPLORA™ customer decoder can store up to 200 such conditional access products. Conditional access products are currently used for updating customer decoders when a customer changes their subscription, for example from a compact subscription in which a limited number of channels are available to a premium subscription in which all channels are available. In this disclosure, the CA system (44) can be used to deliver other conditional access products to customer decoders. For example, if the customer database (34) includes the province of a customer, then a conditional access product called “province” can be defined and loaded onto all corresponding customer decoders, the conditional access product having an identifier of the customer's province. If the customer database (34) includes the birthday of the customer, then a conditional access product called “birthday” can be defined and loaded onto all corresponding customer decoders of those customers that have a birthday on the day the conditional access product is loaded. In this way, customer attributes on the customer database and be defined as conditional access products and loaded onto the customer decoders.

Each customization item (30) has an associated customization item record with a unique identifier (e.g., Ad ID) and a number of target attributes. The target attributes can be configured by a user of the head-end system (12) for each customization item (30) as shown in block 45. The target attributes include customer attributes that relate to groups of customers, which may, as previously described, include a region of the customer (e.g. a province or city name), the type of service(s) the customer has subscribed for (e.g. compact, standard or premium subscription), and demographic information about the customer (e.g. customer age, birthday, gender, income level, and so on).

The target attributes may also include a customer selected service, such as whether the content asset is obtained through a pull or push service. An example of a push service is one where the content asset was previously broadcast (“pushed”) and stored on the decoder device, such as the applicant's CATCHUP™ service. An example of a pull service is one where the content asset is downloaded through a separate Internet connection which may be accessible by certain connected decoder devices.

The customization item record may also include other information specific to the customization item such as a root category, which defines the industry sector to which the customization item belongs (e.g. “insurance” or “banking”).

In the illustrated example in which the customization item is an advertisement (block 45), a customization item record includes a unique identifier (Ad ID) and the following optional target attributes: the country in which the ad must be played, the “Group” to which the ad must be targeted (where “Group” maps to a list of content asset genres as explained below), a linked asset ID in the event that the ad must be linked to a specific content asset, a linked channel in the event that the ad must be linked to a specific channel, a linked studio in the event that the ad must be linked to a specific studio, and a variety of customer attributes to which the ad must be targeted. The record also includes the list of customer selected services, a root category defining the industry sector of the ad, and a watershed rule which specifies whether the ad is permitted to be played only during certain times or not. Finally, the “number of plays” is defined, which is the number of content assets to which the ad should be linked in a particular rule file.

By using the customization item record's available target attributes and other information, business rules can therefore be established to link specific customization items to specific content assets, groups of consumers, and customer selected services, as well as to define how frequently the ad should be played and whether it is only permitted to be played during watershed hours. An example of the way in which customization items are configured is illustrated in block 45. For example, four ads are directed to customers in South Africa. Ad ID 1 is targeted at Group=Men, the root category is Banking and it must be played 5 times. Ad ID 2 is targeted at a specific linked content asset, has a root category of Automotive and must be played 100 times. Ad ID 3 is targeted at customers that have a premium subscription and that play back the content asset using a PULL service. The root category of Ad ID 3 is shown as Insurance and the ad must be played 50 times. Ad ID 7 is a special ad that is only targeted to customers that have the “birthday” conditional access product loaded on their customer devices. It does not have a root category and may simply be a message wishing a customer a happy birthday.

Two ads are directed to customers in Namibia. Ad ID 1 is targeted at Group=Family, has a root category shown as Banking and must be played 60 times. Ad ID 4 is targeted at a specific linked channel (CNN), has a root category of Healthcare and must be played 20 times. This last ad ID 4 will therefore only be played to customers selecting content assets that are linked to CNN.

In addition to establishing business rules by configuring the customization items in block 45, a user of the head-end system (12) can also do system configuration as shown in block 46. This system configuration allows a head-end system administrator to define if each studio does or does not allow ads (e.g. Marvel Entertainment may specify that it does not allow any ads to be played in conjunction with its content), whether a channel allows ads (e.g. Home Box Office may specify that it does not allow any ads to be played on its channel), and to define Groups. Groups are a convenient method of creating identifiers that map a number of specific genres onto one group identifier. For example, by creating a group “Men” and mapping it to a number of genres such as action, sci-fi, comedy and sport, those genres can be grouped together to refer to a particular group of customers. The head-end system administrator can also define those customization items that are not ads, for example preview content, promotional content, channel pre-roll and service pre-roll, and link them to applicable channels and services. A channel pre-roll could be a short video which promotes a particular channel and is also referred to as a “channel sting”, and a service pre-roll could be a short video which promotes a particular user-selected service. A default ad can also be defined by the head-end system administrator to be used when there are no other matches.

The head-end system (12) includes a rules engine (48) which takes all of the customization item configuration rules and system configuration rules previously described and generates a rule file (50). A rule file delivery system (52) then causes broadcasting of the rule file to the customer decoders by means of the satellite (14), each customer decoder storing the rule file on its local memory as a separate digital file. When a content asset is selected for video playback by a user of the customer decoder, the customer decoder uses the rule file to obtain a customization item identifier, and then customizes the playback of the selected content asset by obtaining the customization item corresponding to the customization identifier.

Since content assets and customization items may be added or removed, and customization items configured differently, in one embodiment the rules engine (48) generates the rule file (50) on a periodic basis and the rule file delivery system (52) causes it to be broadcast to the customer decoders periodically, the customer decoders replacing the previously stored rule file with the new one each time a new one is received. The periodic basis may be every day or every certain number of days, at a specific time of day (e.g. midnight). Where an urgent change to content asset customization is required, the rules engine (48) may generate a rule file immediately and the rule file delivery system (52) may cause it to be broadcast. For example, if a particular advertiser ceases sponsoring a certain content asset, the ads of that advertiser can immediately be withdrawn from the sponsored content assets to which it is linked.

Storing of the rule file on the customer decoder does not require any software or logic update to the customer decoder, since the rule file is simply a digital file that is stored and interpreted by the customer decoder. The customer decoder has none of the configuration rules shown in boxes 40, 45 and 46 on its local memory.

The rule file has a hierarchical tree structure with a plurality of nodes at different hierarchical levels of the tree structure, with customer attributes forming nodes at one or more intermediate hierarchical levels of the tree structure and the customization item identifiers forming end nodes of the tree structure. The rule file may be a text file such as a Json™ file, or may be a database file such as a structured query language (SQL) database file, or extensible mark-up language (XML) file. Upon a user-performed action, which may in some embodiments be selection of a content asset for video playback by a user of the customer decoder, the customer decoder traverses or queries the hierarchical tree structure of the rule file by comparing customer attributes that are stored on or accessible by the customer decoder with the customer attributes in the tree structure to obtain a customization item identifier at an applicable end node, and customizes the playback of the selected content asset by obtaining the customization item corresponding to the customization identifier.

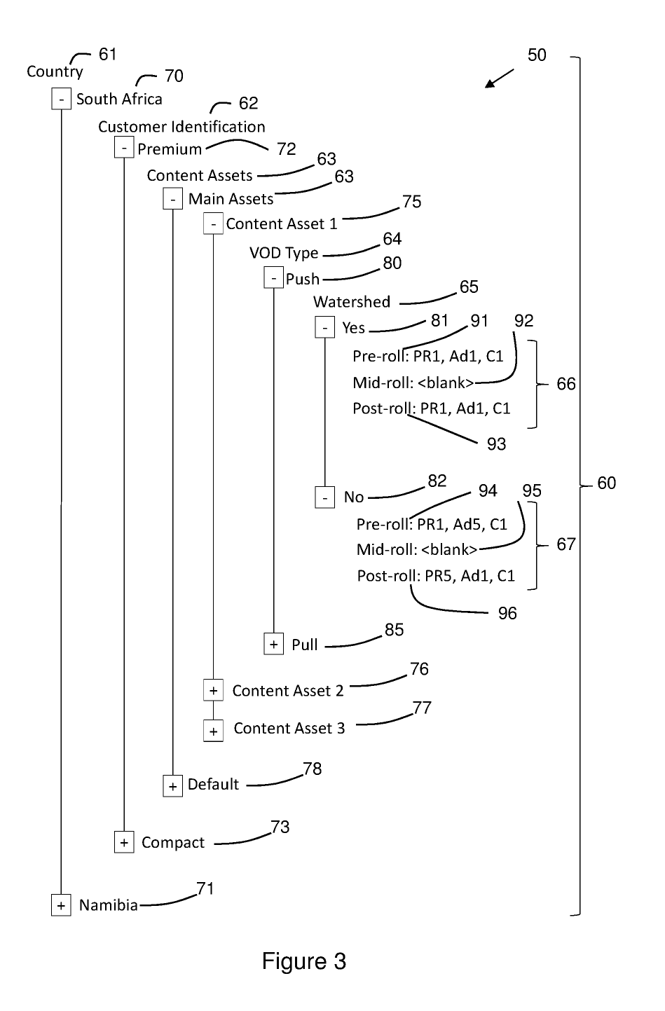

FIG. 3 illustrates one example of a rule file (50) that is a text file, such as a Json™ file. The rule file (50) has a hierarchical tree structure (60) with a number of nodes (61-65) at different hierarchical levels of the tree structure. A first hierarchical level of the tree structure is Country (61). In this exemplary rule file there are two countries—South Africa (70) and Namibia (71). Only South Africa (70) has been expanded and the nodes below Namibia (71) are collapsed. Country (61) is an example of a customer attribute. A second hierarchical level of the tree structure is Customer Identification (62), which is an example of a conditional access product, and there are two nodes, Premium (72) and Compact (73). Customer Identification (62) is an example of another customer attribute that in this case refers to the subscription package that the customer has subscribed to. The identifiers under Customer Identification (62) would have been previously transmitted to the customer decoders (22) using the conditional access system (44).

A third hierarchical level of the tree structure is Content Assets (63) including “Main Assets” (74) and “Default” (75). Under Main Assets (70) are a list of content asset identifier nodes (75-77), in this example content assets 1 to 3. The nodes under Default (78) are used if there is no match under Main Assets (74).

A fourth hierarchical level of the tree structure is Video on Demand (VOD) type (64) and there are two nodes, Push (80) and Pull (85). These are examples of a customer selected service, where

Push (80) refers to content assets that are broadcast from the satellite and Pull (85) refers to content assets that are downloaded from the Internet by connected customer decoders.

A fifth hierarchical level of the tree structure is Watershed (65), and there are two nodes, yes (81) and no (82). Watershed (65) refers to a time of day, where watershed=yes generally may for example mean between 9 pm and midnight and watershed=no refers to midnight to 9 pm.

The end nodes (66, 67) are at a sixth hierarchical level of the tree structure and include the customization item identifiers. Separate pre-roll and post-roll lists of customization item identifiers (91, 94, 93, 96) may be provided, as well as one or more mid-roll lists of customization items (92, 95) to be inserted during the course of content asset playback. In this illustration, under watershed=yes, the pre-roll list of customization item identifiers (91)_is PR1, Ad1, C1, where PR1 refers to a predefined pre-roll video file, Ad1 to an advertisement video file and C1 to a channel sting video file. The post-roll list of customization item identifiers (93) is the same. Under watershed=no, the same pre-roll (PR1) and channel sting (C1) are used, but Ad5 is used between them.

The rule file (50) is interpreted by the customer decoder (22) simply querying or traversing the hierarchical tree structure (60) of the rule file (50) by comparing customer attributes that are stored on or accessible by the customer decoder (22) (which may be offline and may previously have been received as conditional access products) with the customer attributes in the tree structure, comparing a selected content asset identifier with the content asset identifiers in the tree structure, comparing a customer selected service with the customer selected service identifiers, and comparing a time of day with a watershed period defined in the tree structure.

For example, assume that a particular customer decoder (22) user selects Content Asset 1 (75) for playback. The customer decoder (22) is in South Africa (70), the decoder (22) has a conditional access product that identifies the subscription type as premium (72), the selected service for playing back Content Asset 1 (75) is a Push (80) service, and the current time is not in the predefined watershed period (82). By quickly traversing the hierarchical levels of the rule file (50), the pre-roll list of customization item identifiers (94) is obtained: PR1, Ad5, C1, with the post-roll (96) being the same. The customer decoder (22) now builds a playlist and the order is PR1, Ad5, C1, Content Asset 1, PR1, Ad5, C1.

It will be appreciated that traversing the rule file is a simple set of steps for the customer decoder. The customer decoder does not use any content asset attribute or customization item target attribute in determining which customization item to select. The result is simply presented in the rule file, where all of the complexity in defining and obtaining that result resides at the head-end system. Loading and traversing the rule file therefore does not require any software updates to the selection functionality at the customer decoder device, which is advantageous since software updates typically result in a period of interrupted service at the customer decoder. The only complexity on the decoder is a very simple and compact rule file which takes up very little storage space.

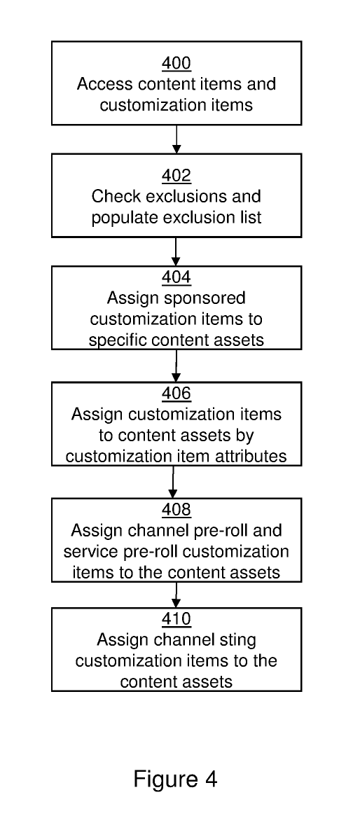

FIG. 4 shows the steps in one exemplary method of generating a rule file (50) carried out by the rules engine (48) at the head-end system (12). To generate the rule file, the rules engine (48) accesses (400) the full list of content assets and customization items, as they have been configured as previously described. The rules engine (48) then checks (402) for exclusions and populates an exclusion list in the rule file. It does this by looking whether any of the content assets have studios or channels in their content asset attributes that do not allow ads. The exclusion list is a separate node in the rule file with a list of content asset identifiers beneath it that do not allow ads.

Next, the rules engine (48) assigns (404) sponsored customization items to specific content assets. Sponsored customization items can be defined in the head-end system (12) so that certain sponsored ads, for example, always appear in front of specific content assets.

The rules engine (48) then assigns (406) customization items to content assets by attribute. This may be an iterative process that can be done in several different ways. In one exemplary embodiment, a list of content assets is sorted and a list of customization items is sorted. The sorting of the list of customization items may be descending order by number of plays, and the list of content assets may be sorted alphabetically by the starting character of the content asset title, with the starting letter changing each time a rule file is generated (e.g. daily). Each content asset may then be selected and compared one by one with the list of customization items in the order of the list, and those customization items that have matching attributes are then mapped to the content asset. A check may also be conducted so as to prevent two or more ads with the same root category from being mapped to the same content asset, and another check may be performed to ensure that there is sufficient available space (in seconds) to include the particular customization item. By repeating this process, the full list of content assets may be mapped to customization items where such mapping is possible.

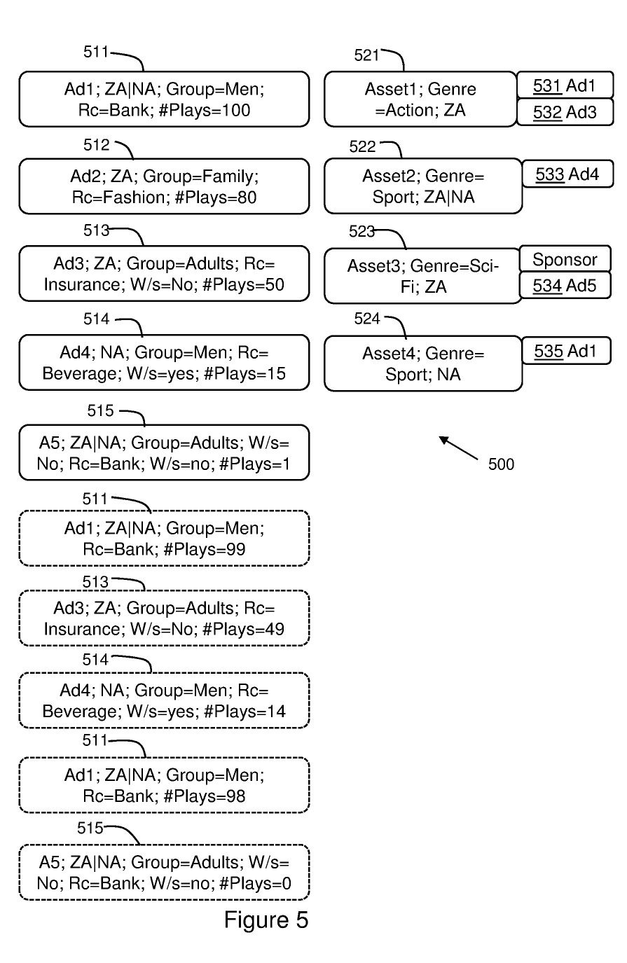

FIG. 5 is schematic diagram (500) illustrating one example of how customization items may be assigned to content assets by using attributes and root categories at step 406. A list of customization items is shown in a left-hand column from Ad1 to Ad5 (511-515), in decreasing order by number of plays. The relevant customization item attributes are shown in respect of each customization item. Note that Watershed is not included in the attributes and all of these ads are watershed=no. The way that watershed=yes ads are dealt with is to have a second list for those ads, and to run through the watershed=yes ads first before the watershed=no ads, so as to make sure that watershed ads have a high probability of being aired during a watershed period.

A list of content assets is shown in a right-hand column from Asset1 to Asset4 (521-524), together with the relevant content asset attributes. In this example, the assets are ordered by title name (A to Z) with the starting letter changing to the next letter each day for each new generation of a daily rule file. This ensures that all content assets have the opportunity to be close to the top of the list at least once every 26 days, corresponding to the number of letters in the Alphabet.

For this example, assume that the “Men” group has been mapped to the following Genres: Action|Sci-Fi|Comedy|Sport, that the “Family” group has been mapped to Comedy|Drama|Romance and the “Adults” group has been mapped to Action|Sci-Fi|Comedy|Sport|Drama|Romance.

The rules engine (48) first compares Ad1 (511) to Asset1 (521). Each Ad1 attribute matches an Asset1 attribute and Ad1 is therefore mapped to Asset1 as shown at (531). Ad1's number of plays is decremented to 99 and it is moved to the bottom of the list so that Ad2 (512) now forms the top of the list. The rules engine (48) then checks if there is available space for Asset1 (521) to have another ad associated with it, which in this case there is. The rules engine (48) compares Ad2 (512) to Asset 1 (521). They do not match because the genre “Action” is not in the Family group.

The rules engine (48) then compares Ad3 (513) to Asset 1 (521) and checks for any conflict in root categories with existing ads mapped to Asset1. The attributes match, and the root category “Bank” of Ad1 which is already mapped to Asset1 is different to the root category “Insurance” of Ad3. Ad3 is therefore mapped to Asset1 as shown at (532), Ad3's number of plays is decremented to 49 and it is moved to the bottom of the list. There is no further available space for more ads to be mapped to Asset1 (521).

The rules engine (48) then moves on to Asset2 (522) and compares it with the top of the ad list which is now Ad2 (512). They do not match because the genre “Sport” is not in the group “Family”. The next ad in the list is Ad4 (514). Asset2 (522) and Ad4 (514) match and are then mapped as shown at (533). Ad4's number of plays is decremented to 14 and it is moved to the bottom of the list.

The order of the ad list from top to bottom is now Ad2 (512), Ad5 (515), Ad1 (511), Ad3 (513), Ad4 (514). Assume that Ad4 (514) is a long ad and there is no space available for Asset 2 (522) to have another ad associated with it. The rules engine (48) then moves on to Asset 3 (523). In this case, Asset3 (523) already has a sponsored ad mapped to it during stage 404 in FIG. 4. Assume that the root category of that ad is “Fashion” and that there is space for another available ad. The rules engine (48) compares Asset3 (523) with Ad2 (512) at the top of the ad list. They do not match because their root categories clash and because the “Sci-Fi” genre of Asset3 (523) does not match the group “Family”. The rules engine (48) then compares Asset3 (523) with Ad5 (515). All attributes match and Ad5 (515) is mapped onto Asset3 as shown at (534). Ad5's number of plays is decremented from 1 to zero and it is moved to the bottom of the list. The order of the list is now Ad2 (512), Ad1 (511), Ad3 (513), Ad4 (514), Ad5 (515).

Assume that Asset 3 (523) has no more space available. The rules engine (48) then moves on to Asset4 (524) and compares it with Ad2 (512) at the top of the list. The do not match because the genre “Sport” and group “Family” do not match. The rules engine (48) then compares Asset4 (524) to Ad1 (511). They match and Ad1 (511) is mapped to Asset4 (524) as shown at (535). Ad1's number of plays is decremented to 98 and Ad1 (511) is moved to the second last item in the list, one above A5 (515) which has reached zero plays. Note that once the number of plays reaches zero, the ad remains at the bottom of the list; however, if no other ads can be assigned to an asset, this ad will be assigned and over delivery of the ads may take place. Ads for which the number of plays is achieved will have the lowest probability of being assigned to assets. If an ad with a zero number of plays is assigned to a content asset, the number of plays will become a negative number and will move down the list.

By iterating this process, an entire list of assets can have ads assigned to them by attribute, where root categories do not clash with each other. The rules engine (48) can then build the rule file and allocate the identifier of each mapped ad beneath a hierarchical level that has the identifiers of each content asset, as previously discussed in relation to FIG. 3.

Referring back to FIG. 4, the final two steps in the method of creating the rule file is to assign (408) channel pre-roll and service pre-roll customization items to the relevant content assets, and to assign (410) channel sting customization items to the relevant content assets, by checking the content asset attributes. The rules in the system configuration block 46 are used to do the necessary linking of channel pre-roll, service pre-roll and channel sting customization items to content assets, which is based on the configured channel and studio of each content asset.

At this stage, the logic of the rule file is complete and the hierarchical rule structure can be output in a format similar that shown in FIG. 3, where it can be traversed by the customer decoder.

It will be appreciated that in the above description, all of the business rule logic is provided at the head-end system, and the decoder is simply provided with a rule file that can be interpreted without the decoder knowing anything about the attributes of the content assets or customization items. No software modification is required when the rule file changes, and a new rule file is simply loaded onto the customer decoder on a regular basis.

While in some described embodiments the customization items are digital video files, in other embodiments the customization items are digital files that may include instructions to the customer decoder to modify a user interface defined by the customer decoder. Such instruction may include, for example, instructions to the customer decoder to select from one more layout or menu format option, background display option, accessibility option such as font size, or any other user interface feature or functionality. The technology described herein can therefore permit several customers or groups of customers to be provided with different user interface options. For example, customers that select a “poor eyesight” option when subscribing for a service can be provided with a larger menu format than other customers. This can be done by creating an “eyesight” field in the customer database (34), and providing those customers with the “eyesight=poor” option with an identification product such as a conditional access product, and then including the “eyesight” field as an intermediate hierarchical level in the rule file, where an end node of the rule file instructs the customer decoder to select an applicable menu option or other user interface for those customers.

For those customer decoders that are connected, feedback reports to the head-end system on which customization assets are utilized can be provided.

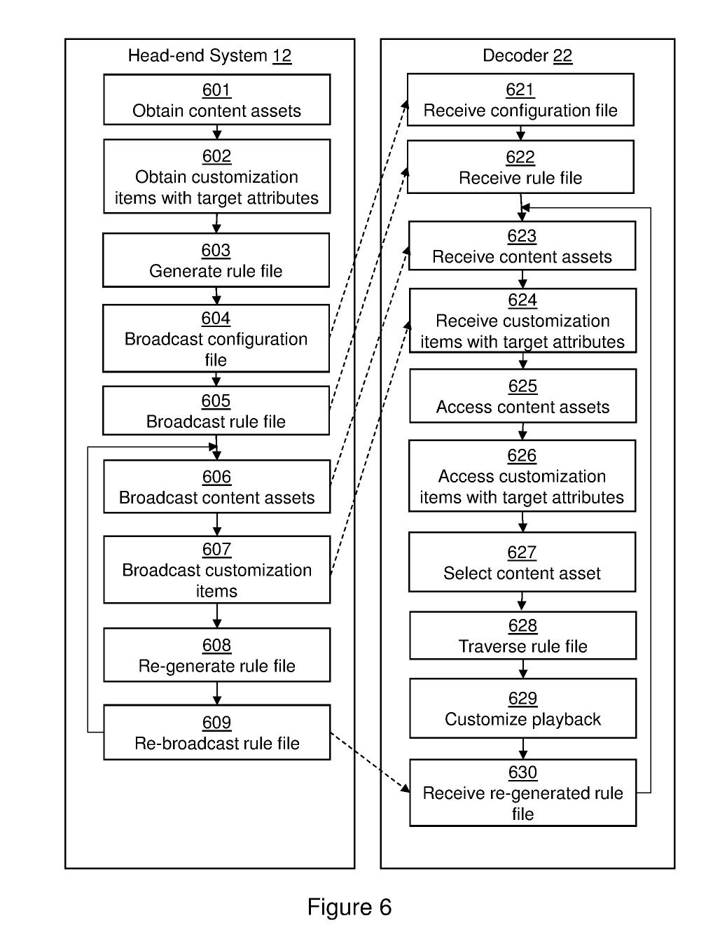

Referring to FIG. 6, a swim-lane flow diagram shows an example embodiment of a method carried out at a head-end system (12) and a corresponding method carried out at a customer decoder (22). The communication between the head-end system (12) and multiple customer decoders (22) provides video content playback broadcasting as described in relation to FIG. 1.

As described with reference to FIG. 2, the head-end system (12) may obtain (601) content assets from a database and may obtain (602) customization items from a database with associated target attributes including customer attributes. The head-end system (12) may generate (603) a rule file in the form of a text file or a database file. The rule file has a hierarchical tree structure with a plurality of nodes at different hierarchical levels of the tree structure and the customer attributes form nodes at one or more intermediate hierarchical levels of the tree structure and the customization item identifiers form end nodes of the tree structure as described with reference to Figure to 3.

The method at the head-end system (12) may cause broadcasting (604) of a configuration file to the customer decoders (22) including a list of customer identifiers and for each customer identifier one or more customer attributes to be associated with that customer identifier. The configuration file may be as generated by the CA system (44) as described in FIG. 2. The head-end system (12) may also cause broadcasting (605) of the rule file to a plurality of customer decoders (22). These may be broadcast on a discrete periodic basis.

The head-end system (12) may cause broadcasting (606) of the content assets as separate digital video files to the customer decoders for the customer decoders to store as digital video files on the local memory. Broadcasting of the content assets may be carried out in a sequential manner in which the content assets are included in a carousel and broadcast one after the other with the sequence repeating.

The head-end system (12) may cause broadcasting (607) of the customization items as separate digital files to the customer decoders for the customer decoders to store on the local memory. Broadcasting of the customization items may be carried out in a sequential manner in which the customization items are included in a carousel and broadcast one after the other with the sequence repeating.

The head-end system (12) may re-generate (608) the rule file and may and re-broadcast (609) the rule file on a periodic basis.

The head-end system (12) may have a VOD delivery system (42) as described in FIG. 2 that broadcasts the content assets and the customization items to the customer decoders (22). These may be continually broadcast on a repeating routine. The head-end system (12) may have a rule delivery system (52) for broadcasting the rule file that may be on a discrete periodic basis. The head-end system (12) may have a CA system (44) for broadcasting the configuration file that may be on a discrete periodic basis.

As will be appreciated, the order of the steps shown in FIG. 6 at the head-end system (12) is for illustration purposes and the broadcasting of the content assets, customization items, rule file and configuration file may take place simultaneously.

At a customer decoder (22), which may be one of many such customer decoders (22) serviced by the head-end system (12), a method may receive (621) a configuration file as broadcast by the CA system (44) of the head-end system (12) and may receive (622) a rule file as broadcast by the rule file delivery system (52) of the head-end system (12) and these may be stored by the customer decoder (22) on local memory at the customer decoder (22).

A customer decoder (22) may receive (623) the content assets as separate digital video files as broadcast by the head-end system (12) and may store the content asset digital video files on the local memory. The content assets may be received in a sequential manner in which the content assets are included in a carousel and broadcast one after the other with the sequence repeating.

A customer decoder (22) may receive (624) the customization items as separate digital files at the customer decoder as broadcast by the head-end system (12) and the customer decoder (22) may store the content customization digital files on the local memory. The customization items may be received in a sequential manner in which the customization items are included in a carousel and broadcast one after the other with the sequence repeating.

The customer decoder (22) may access (625) a number of the received and stored content assets, with content assets having an identifier and may access (626) a number of customization items that each has an identifier and that each has one or more target attributes, the target attributes including customer attributes that relate to groups of customers.

In one embodiment, the customer decoder (22) may select (627) a content asset for video playback by a user of the customer decoder and the customer decoder (22) may traverse (628) or query the hierarchical tree structure of the received and stored rule file by comparing one or more customer attributes that are stored on or accessible by the customer decoder (22) with the customer attributes in the tree structure to obtain a customization item identifier at an applicable end node. The customer decoder (22) may then customize (629) the playback of the selected content asset by obtaining the customization item corresponding to the customization identifier. As described in relation to FIG. 5, the method may iterate to customize multiple content assets with multiple customization items for playback.

In another embodiment, the customization (629) may be carried out according to the rule file without specific selection (627) of a content asset at the customer decoder (22). The customer decoder (22) may traverse (628) or query the hierarchical tree structure of the rule file by comparing one or more customer attributes that are stored on or accessible by the customer decoder with the customer attributes in the tree structure to obtain a customization item identifier at an applicable end node, and may customize (629) all video at the customer decoder by obtaining the customization item corresponding to the customization identifier. In this embodiment, the rule file may be used to change a format of a display at the customer decoder (22) for all video playback, for example, to accommodate different user interface options for accessibility requirements such as poor eyesight.

The customer decoder (22) may periodically receive (630) a re-generated rule file and the customer decoder (22) may replace an existing rule file stored on the local memory with the most recently broadcast rule file.

As will be appreciated, the order of the steps shown in FIG. 6 at the customer decoder (22) is for illustration purposes and the receiving of the content assets, customization items, rule file and configuration file may take place simultaneously.

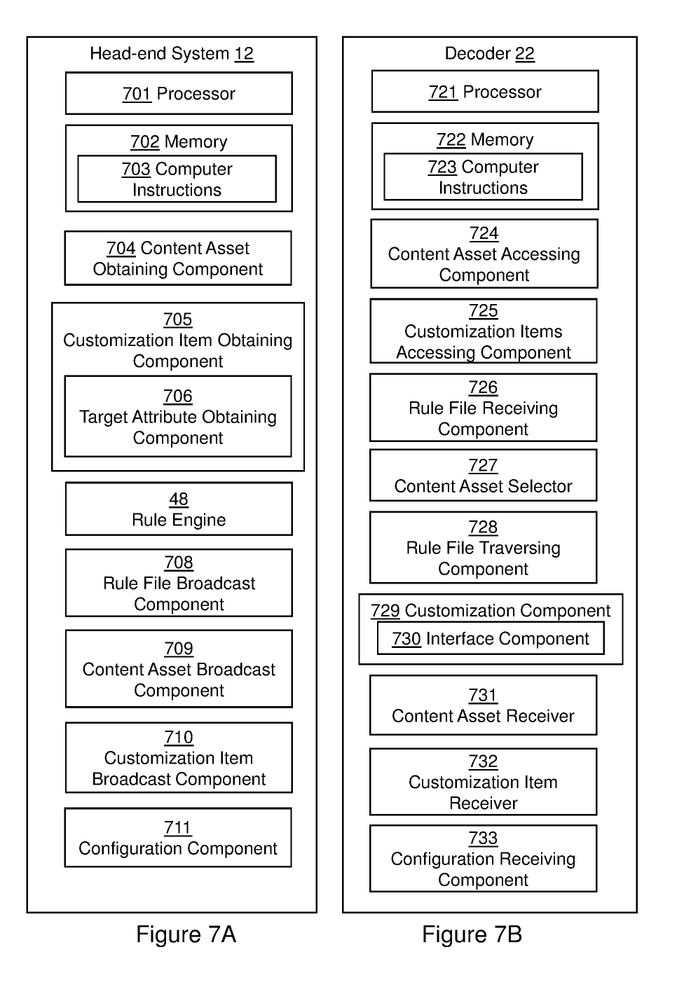

Referring to FIG. 7A, an example embodiment of a head-end system (12) is shown. The head-end system (12) may include a processor (701) for executing the functions of components described below, which may be provided by hardware or by software units executing on the head-end system (12). The software units may be stored in a memory (702) and instructions may be provided to the processor (701) to carry out the functionality of the described components. In some cases, for example in a cloud computing implementation, software units arranged to manage and/or process data on behalf of the head-end system (12) may be provided remotely.

The memory (702) may be configured to provide computer instructions (703) to the processor (701) to carry out the described functions of the head-end system (12).

The head-end system (12) may include a content asset obtaining component (704) for obtaining a number of content assets and a customization item obtaining component (705) for obtaining a number of customization items including a target attribute obtaining component (706) for obtaining one or more target attributes for each customization item.

The head-end system (12) may include rule engine (48) for generating a rule file with a hierarchical tree structure as described. The rule engine (48) may generate the rule file by matching the content asset attributes with customization item target attributes so as to match customization items with content assets, and to include content asset identifiers at an intermediate hierarchical level of the tree structure. The rule file engine (48) may re-generate the rule file on a periodic basis. The head-end system (12) may include rule file broadcast component (708) for causing broadcasting of the rule file to a plurality of customer decoders (22) via a rule file delivery system (52).

The head-end system (12) may also include a configuration component (711) for generating and broadcasting a configuration file, for example, via a CA system (44), as an initial step to the customer decoders (22) including a list of customer identifiers and for each customer identifier one or more customer attributes to be associated with that customer identifier.

The head-end system (12) may also include a content asset broadcast component (709) for causing broadcasting of the content assets as separate digital video files to the customer decoders (22) and a customization item broadcast component (710) for causing broadcasting of the customization items as separate digital files to the customer decoders (22). These may cause the VOD delivery system (42) to broadcast the content assets and customization items.

Referring to FIG. 7B, an example embodiment of a customer decoder (22) is shown, for example, in the form of a set-top box for a television. The decoder (22) may include a processor (721) for executing the functions of components described below, which may be provided by hardware or by software units executing on the decoder (22). The software units may be stored in a memory (722) and instructions may be provided to the processor (721) to carry out the functionality of the described components. The memory (722) may be configured to provide computer instructions (723) to the processor (721) to carry out the described functions of the decoder (22).

The customer decoder (22) may include a content asset receiver (731) for receiving the content assets as separate digital video files and a customization item receiver (732) for receiving the customization items as separate digital files as broadcast by the head-end system (12).

The customer decoder (22) may include a content asset accessing component (724) for accessing a number of stored content assets and a customization item accessing component (725) for accessing a number of the stored customization items.

The customer decoder (22) may include a rule file receiving component (726) for receiving a rule file and storing the rule file on a local memory of the customer decoder (22). The rule file receiving component (726) may receive a re-generated rule file on a periodic basis and the customer decoder (22) may replace an existing rule file stored on the local memory with the most recently broadcast rule file. The customer decoder (22) may also include a configuration file receiving component (733) for receiving a configuration file.

The customer decoder (22) may include a content asset selector (727) for selecting a content asset for video playback, a rule file traversing component (728) for traversing or querying the hierarchical tree structure of the rule file, and a customization component (729) for customizing the playback of the selected content asset by obtaining the customization items and causing playback of the stored customization item in association with the content asset. In one embodiment, the customization component (729) includes an interface component (730) for modifying a user interface defined by the customer decoder (22) in accordance with instructions provided by the customization items.

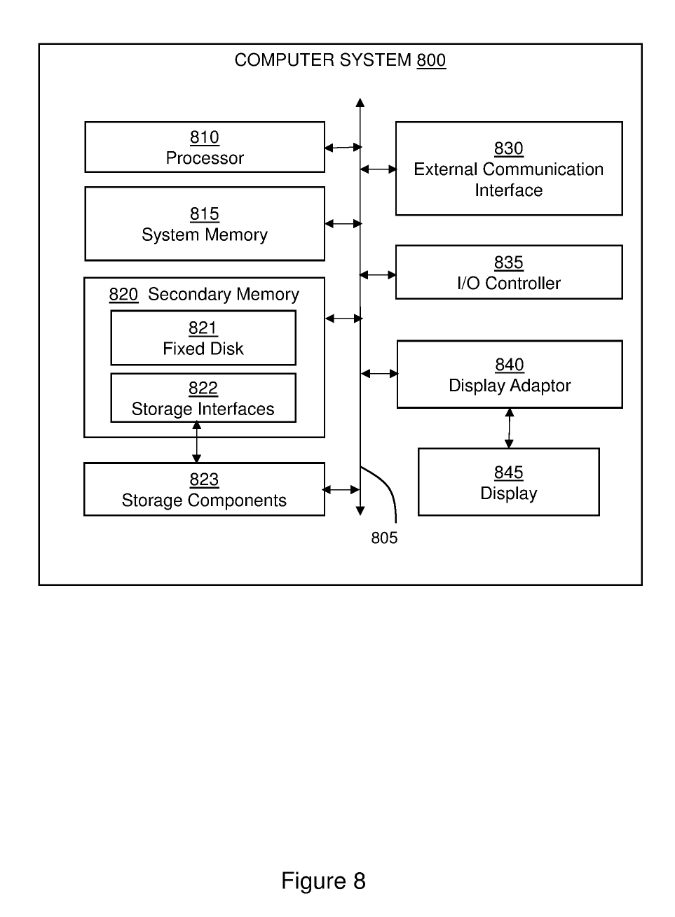

FIG. 8 illustrates an example of a computing system (800) in which various aspects of the disclosure may be implemented. The computing system (800) may be embodied as any form of data processing device including a decoder device and a head-end system in the form of a server computer (which may be self-contained, physically distributed over a number of locations) as described herein. Different embodiments of the computing system may dictate the inclusion or exclusion of various components or subsystems described below.

The computing system (800) may be suitable for storing and executing computer program code. The various participants and elements in the previously described system diagrams may use any suitable number of subsystems or components of the computing system (800) to facilitate the functions described herein. The computing system (800) may include subsystems or components interconnected via a communication infrastructure (805) (for example, a communications bus, a network, etc.). The computing system (800) may include one or more processors (810) and at least one memory component in the form of computer-readable media. The one or more processors (810) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing system (800) may be distributed over a number of physical locations (e.g. in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing system (800) may include an external communications interface (830) for operation of the computing system (800) in a networked environment enabling transfer of data between multiple computing systems (800) and/or the Internet. Data transferred via the external communications interface (830) may be in the form of signals, which may be electronic, electromagnetic, optical, radio, or other types of signal. The external communications interface (830) may enable communication of data between the computing system (800) and other computing systems including servers and external storage facilities. Web services may be accessible by and/or from the computing system (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient computer-readable medium, or may be provided via a signal or other transient means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing system (800) either directly or via an I/O controller (835). One or more displays (845) (which may be touch-sensitive displays) may be coupled to or integrally formed with the computing system (800) via a display (845) or display adapter (840).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method of customizing broadcast video, the method performed at a head-end computer system and comprising:
obtaining a number of content assets, each content asset being a digital video file that has an identifier;
obtaining a number of customization items, each customization item being a digital file that has an identifier;
for each customization item, obtaining one or more target attributes, the target attributes including customer attributes that relate to groups of customers;
generating a rule file, the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
causing broadcasting of the rule file to a plurality of customer decoders, each customer decoder storing the rule file on a local memory of the customer decoder; and
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization item identifier.

2. The method as claimed in claim 1 wherein the customer decoder traverses or queries the hierarchical structure of the rule file upon selection of a content asset for video playback by a user of the customer decoder, and wherein the customer decoder customizes playback of the selected content asset.

3. (canceled)

4. The method as claimed in claim 1 wherein the target attributes include a customer-selected service, the customer selected service forming nodes at a further intermediate hierarchical level of the tree structure.

5. The method as claimed in claim 1 wherein each content asset has a number of content asset attributes, the target attributes of each customization item includes content asset attributes, and generating the rule file includes matching the content asset attributes with customization item target attributes so as to match customization items with content assets, and to include content asset identifiers at an intermediate hierarchical level of the tree structure.

6. The method as claimed in claim 5 wherein the content asset attributes are selected from: a channel in which the content asset is broadcast, a season of the content asset, a series to which the content asset belongs, a studio which created the content asset, or a genre of the content asset.

7. (canceled)

8. (canceled)

9. (canceled)

10. The method as claimed in claim 1 wherein the customization items are instructions to the customer decoder to modify a user interface defined by the customer decoder.

11. The method as claimed in claim 1, including:
causing broadcasting of the content assets as separate digital video files to the customer decoders, the customer decoders storing the content asset digital video files on the local memory; and
causing broadcasting of the customization items as separate digital files to the customer decoders, the customer decoders storing the content customization digital files on the local memory.

12. The method as claimed in claim 11 wherein broadcasting of the content assets is done in a sequential manner in which the content assets are included in a carousel and broadcast one after the other with the sequence repeating.

13. The method as claimed claim 11 wherein broadcasting of the customization items is done in a sequential manner in which the customization items are included in a carousel and broadcast one after the other with the sequence repeating.

14. (canceled)

15. The method as claimed in claim 1 including an initial step of broadcasting a configuration file to the customer decoders, the configuration file including a list of customer identifiers and for each customer identifier one or more customer attributes to be associated with that customer identifier, wherein a customer decoder linked to a customer identifier stores an applicable customer attribute.

16. (canceled)

17. (canceled)

18. (canceled)

19. A computer-implemented method of customizing broadcast video, the method performed at a customer decoder and comprising:
accessing a number of content assets, each content asset being a digital video file that has an identifier;
accessing a number of customization items, each customization item being a digital file that has an identifier and wherein each customization item has one or more target attributes, the target attributes including customer attributes that relate to groups of customers;
receiving a rule file and storing the rule file on a local memory of the customer decoder the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure; and
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization item identifier.

20. The method as claimed in claim 19 wherein the customer decoder traverses or queries the hierarchical structure of the rule file upon selection of a content asset for video playback by a user of the customer decoder, and wherein the customer decoder customizes playback of the selected content asset.

21. The method as claimed in claim 20 wherein the customer decoder traverses or queries the hierarchical tree structure by comparing a service through which the content asset is selected with the customer selected service in the tree structure.

22. The method as claimed in claim 20 wherein the customer decoder customizes the content asset by causing playback of the stored customization item in association with the content asset.

23. The method as claimed in claim 19 wherein the customization items are instructions to the customer decoder to modify a user interface defined by the customer decoder.

24. The method as claimed in claim 19, including:
receiving the content assets as separate digital video files at the customer decoder, the customer decoders storing the content asset digital video files on the local memory; and
receiving the customization items as separate digital files at the customer decoder, the customer decoder storing the content customization digital files on the local memory.

25. (canceled)

26. (canceled)

27. (canceled)

28. The method as claimed in claim 19 including an initial step of receiving a configuration file including a list of customer identifiers and for each customer identifier one or more customer attributes to be associated with that customer identifier, wherein a customer decoder linked to a customer identifier stores an applicable customer attribute.

29. (canceled)

30. (canceled)

31. A system for customizing broadcast video, the system including a head-end system including a memory for storing computer-readable program code and a processor for executing the computer-readable program code, the head-end system comprising:
a content asset obtaining component for obtaining a number of content assets, each content asset being a digital video file that has an identifier;
a customization item obtaining component for obtaining a number of customization items, each customization item being a digital file that has an identifier;
a target attribute obtaining component, for each customization item, obtaining one or more target attributes, the target attributes including customer attributes that relate to groups of customers;
a rule engine for generating a rule file, the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure;
a rule file broadcast component for causing broadcasting of the rule file to a plurality of customer decoders, each customer decoder storing the rule file on a local memory of the customer decoder;
wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and customizes video at the customer decoder by obtaining the customization item corresponding to the customization item identifier.

32. (canceled)

33. (canceled)

34. The system as claimed in claim 31, wherein the head-end system includes:
a content asset broadcast component for causing broadcasting of the content assets as separate digital video files to the customer decoders, the customer decoders storing the content asset digital video files on the local memory; and
a customization item broadcast component for causing broadcasting of the customization items as separate digital files to the customer decoders, the customer decoders storing the content customization digital files on the local memory.

35. (canceled)

36. (canceled)

37. (canceled)

38. (canceled)

39. The system as claimed in claim 31, including a customer decoder for customizing broadcast video the decoder including a memory for storing computer-readable program code and a processor for executing the computer-readable program code, the customer decoder comprising:
a content asset accessing component for accessing a number of content assets, each content asset being a digital video file that has an identifier;
a customization item accessing component for accessing a number of customization items, each customization item being a digital file that has an identifier and wherein each customization item has one or more target attributes, the target attributes including customer attributes that relate to groups of customers;
a rule file receiving component for receiving a rule file and storing the rule file on a local memory of the customer decoder the rule file having a hierarchical tree structure with a plurality of nodes at different hierarchical levels of the tree structure, wherein the customer attributes form nodes at one or more intermediate hierarchical levels of the tree structure and the customization item identifiers form end nodes of the tree structure; and
a rule file traversing component, wherein the customer decoder traverses or queries the hierarchical tree structure of the rule file by comparing one or more customer attributes that are stored on or accessible by the customer decoder with the customer attributes in the tree structure to obtain a customization item identifier at an applicable end node, and a customization component for customizing video at the customer decoder by obtaining the customization item corresponding to the customization item identifier.

40. (canceled)

41. (canceled)

42. (canceled)

43. (canceled)

44. (canceled)

45. (canceled)

46. (canceled)

47. (canceled)

48. (canceled)

49. (canceled)

50. (canceled)
